(19) United States
(12) Patent Application Publication
(10) Pub. No.: US 2009/0296132 A1
(43) Pub. Date: Dec. 3, 2009

(54) METHOD FOR CALCULATION OF AN IMPOSITION LAYOUT

(76) Inventor: Orly Leusouich Frank, Herzlia (IL)

Correspondence Address: Amelia A. Buharin;Patent Legal Staff, Eastman Kodak Company, 343 State Street, Rochester, NY, 14650-2201, US

(21) Appl. No.: 12/127,140

(22) Filed: May 27, 2008

(51) Int. Cl. G06K 15/00

(52) U.S. Cl. 358/1.15

(57) ABSTRACT

A method for calculating properties of printing elements which are part of a print job includes providing a range (112) of sheets for printing; providing desired imposition schemes (200) for the print job; calculating a set of printing elements (134) required for the range of sheets for printing according to a desired imposition schemes; splitting a set of printing elements into plurality of printing elements subsets where each of the subsets contain less printing elements than in the set of printing elements; calculating processing parameters (512), required for processing of printing elements, for each of the printing elements subsets; calculation of the printing elements and processing parameters is performed without calculation of the imposition layout.

### CROSS REFERENCE TO RELATED APPLICATIONS

Reference is made to commonly-assigned copending U.S. patent application Ser. No. 12/060,910, filed Apr. 2, 2008, entitled DISTRIBUTED PROCESSING OF PRINT JOBS, by Leonid Khain, the disclosure of which is incorporated herein.

### FIELD OF THE INVENTION

The present invention relates to methods for calculation of parameters for digital pages processing by digital front ends without performing a page imposition on the related printing job.

### BACKGROUND OF THE INVENTION

Digital color servers receiving print jobs for processing often derive relevant parameters needed for processing and preparation from an earlier job imposition stage. Each of the digital pages comprising the print job should receive orientation and position information in order to be processed correctly. This problem is being solved in various techniques which are common today.

Some vendors perform full job imposition before submission of the print job for processing. This is similar to upstream imposition, meaning imposition is done at the DeskTop Application (DTP) stage. (This exists in electronic for imaging.) In this case, parameters for page processing are derived from the previously performed imposition. This method suffers from performance problems and does not allow for last minute imposition. For example, a single altered page, which is part of a certain imposition scheme, requires imposition processing to be redone, and hence re-submission of a print job to the color server.

The Kodak NexStation server configured to drive the Kodak NexPress digital printer tackles this problem differently. NexStation performs full imposition before processing the pages contained in the print job. The processing will process a complete flat, and all the pages are part of one side of a single printing sheet. The NexStation processes only page description format (PDF) pages.

PDF format, unlike pages that are described in PostScript (PS), enable page random access and as such can be easily altered without the need of re-imposition. However, this limitation of consuming PDF only pages is a difficult limitation for a color server and requires extra conversion time to prepare the print job PDF pages, and additionally, changes in the imposition scheme, which require reprocessing of the print job.

Current versions of some color servers require imposition to be performed twice. The first time it is done is for the page processing stage and the second for the full page imposition before the actual print is performed. This carries inherent performance problem. The first imposition is performed to derive parameters required for correct print job page processing. This process of layout imposition is done according to the order of pages and is a very lengthy process.

There is a need for a method to calculate parameters for page processing without the need to perform an early layout imposition. The present invention proposes performing a single job imposition stage just before the actual print of the relevant print job.

### SUMMARY OF THE INVENTION

Briefly, according to one aspect of the present invention a method for calculating properties of printing elements, wherein the printing elements are part of a print job, includes providing a range of sheets for printing; providing the desired imposition schemes for the print job; calculating a set of printing elements required to the range of sheets for printing according to the desired imposition schemes; splitting the set of printing elements into plurality of printing elements subsets, wherein each of the subsets contains less printing elements than in the set of printing elements; calculating processing parameters for each of the printing elements subsets, wherein the processing parameters are required for processing of the printing elements; and wherein calculation of the printing elements and the processing parameters are performed without calculation of the imposition layout of the sheets.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

FIG. 1 is a schematic flow illustrating calculation of pages needed to process a certain print job;

FIG. 2 is illustrating a template for calculation of page ranges for saddle stitch and perfect bound imposition of 4 pages on 2 front sheets or 2 back sheets;

FIG. 3 is an example of imposition layout structure for a certain sheet range deriving relevant page ranges required for processing of saddle stitch imposition;

FIG. 4 is a additional example of imposition layout structure for a certain sheet range deriving relevant page ranges required for processing of perfect bound imposition;

FIG. 5 is a schematic flow illustrating calculation of page rules needed to process a certain print job;

FIG. 6 is illustrating a template for calculation of page ranges for saddle stitch and perfect bound imposition;

FIG. 7 is an example of perfect imposition layout structure for a certain sheet range deriving relevant page ranges required for processing of saddle stitch imposition; and

FIG. 8 is an example of perfect imposition layout structure for a certain sheet range deriving relevant page ranges required for processing of perfect bound imposition.

### DETAILED DESCRIPTION OF THE INVENTION

The method disclosed hereunder suggests solutions to two related major problems. The first is, calculating needed pages or printing elements which are part of a desired range of sheets requested to be printed by a user. The second is calculating process rules which are related to specific printing elements. For exemplary purposes rules can represent: page orientation, color profiles associated with printed sheets and other attributes. Color profiles and other attributes may depend upon where a page will be printed. Which set number, sheet number, and sheet side (front or back)?

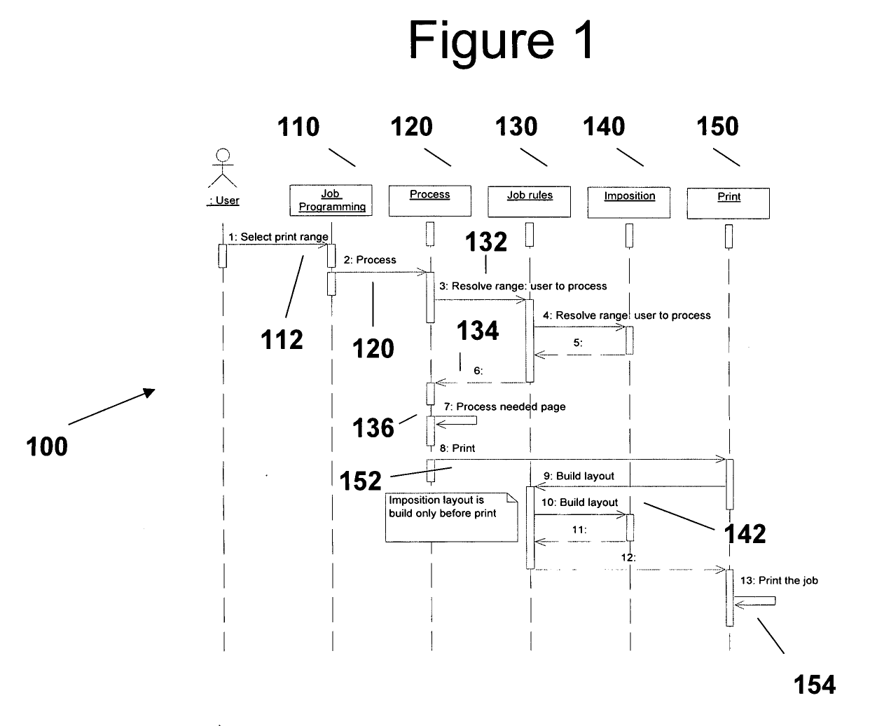

FIG. 1 describes a flowchart 100 illustrating the calculation of pages needed in order to process a certain print job.

A sheet print range 112 is selected by the user during the job programming stage 110. The sheet print range 112 is provided to the processing stage 120. The processing stage 120 starts a resolving page range inquiry 132 for finding out which pages (or printing elements) will participate in the printing of the previously selected sheet print range 112. The list of the resolved pages 134 is returned from the job rules stage 130 and the imposition stage 140 back into processing stage 120. The processing stage will start the processing of resolved pages 136. The printing of the processed pages will start 152 by invoking print stage 150. The print stage will trigger the build imposition layout 142 process to prepare the data before the actual printing of the job 154.

The method for resolving the printing elements that participate in a given sheet print range might differ between different imposition schemes. The examples below explain the calculation of resolving of pages from a given sheet range in the cases of saddle stitch, perfect bound and step, and continue imposition schemes.

A method for resolving pages from a saddle stitch imposition given a sheet range is described hereunder in a Meta language form.

From sheet range to process range Saddle stitch

int pageCount //number of pages in the job
int uniquePagesInTemplate // unique pages in template
int pagesInFlat = uniquePagesInTemplate / 2
int minPage //minimum page in template
int maxPage //maximum page in template
int midPage = pagesInFlat;
int from1 = minPage + (sheet from number − 1) *
uniquePagesInTemplate;
int to1 = minPage + (sheet to number − 1) * uniquePagesInTemplate;
to1 = Math.min(to1, pageCount); //max pages
int pagesInSet //number of pages in a set, job round to full sheet
int from2 = pagesInSet − (uniquePagesInTemplate − (midPage +1)) −
(pagesInFlat * (sheet from number − 1));
int to2 = pagesInSet − (uniquePagesInTemplate − maxPage) −
(pagesInFlat * (sheet to number − 1));
to2 = Math.min(to2, pageCount); //max pages

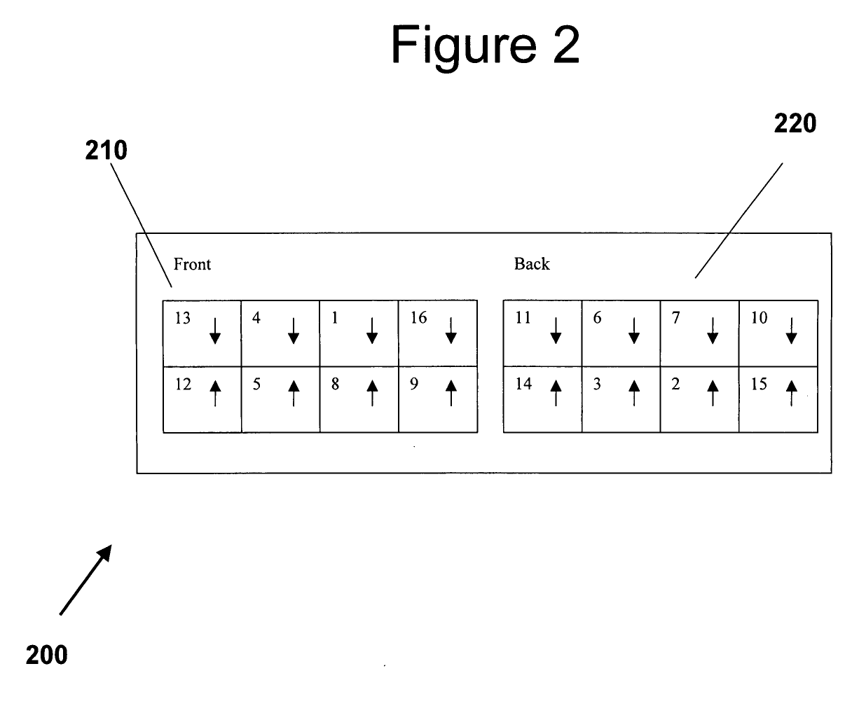

FIG. 2 describes a saddle stitch and perfect bound imposition template 200. Template 200 comprises a front side sheets template 210 and a back side sheets template 220.

Template 200 is used for resolving pages from a given a sheet range of a saddle stitch 4×2 (4 printing elements on 2 sheets) imposition.

An example of an 85 page job is provided. Pages needed to be resolved from the job within a given print sheets range 4-5.

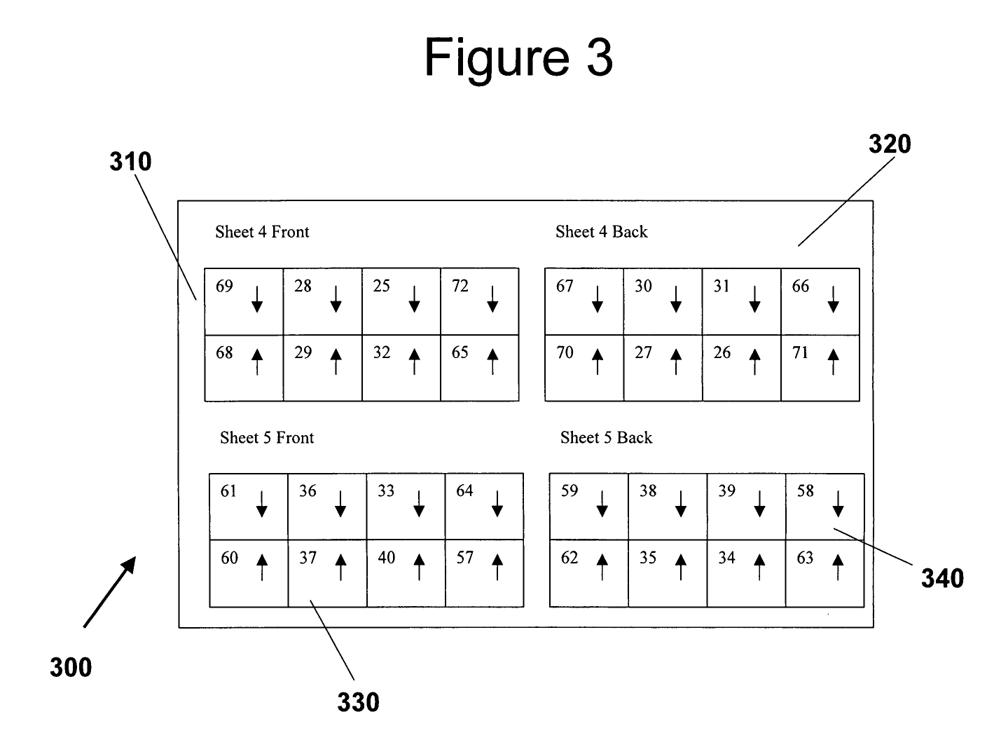

FIG. 3 describes the resulted layout 300 for sheets 4-5 given a job of 85 pages. The calculated layout 300 comprises 4 flats: front side sheet 4 (310), back side sheet 4 (320), front side sheet 5 (330) and back side sheet 5 (340). The resolved pages to be processed for sheet 4-5 are 25-40 and 57-72 in the case of a saddle stitch imposition. The result of this calculation according to the described method will yield the following results:

from 1=25

to 1=40

from 2=57

to 2=72

A method for resolving pages from a perfect bound or step and continue imposition given a sheet range is described hereunder in a Meta language form.

From sheet range to process range Perfect bound / Step & Continue

int pageCount //number of pages in the job
int uniquePagesInTemplate // unique pages in template
int pagesInFlat = uniquePagesInTemplate / 2
int minPage //minimum page in template
int maxPage //maximum page in template
int midPage = pagesInFlat;
int from = minPage + (sheet from number − 1) *
uniquePagesInTemplate;
int to = minPage + (sheet to number − 1) * uniquePagesInTemplate;
to = Math.min(to, pageCount); //max pages

An example of a 130 page job is provided. Pages needed to be resolved from the job within a given print sheets range 6-7 given a perfect bound imposition 4×2 (4 pages on 2 sheets) will be used.

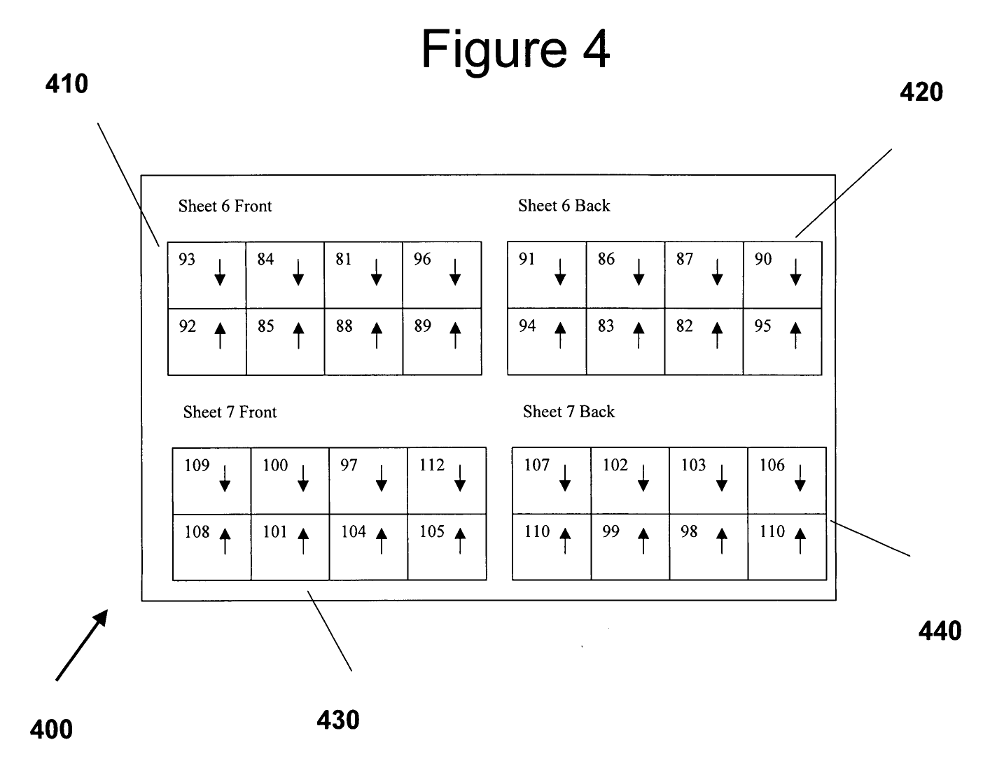

FIG. 4 describes the resulted perfect bound layout 400 for sheets 6-7 given a job of 130 pages.

The calculated layout 400 comprises 4 flats: front side sheet 6 (410), back side sheet 6 (420), front side sheet 7 (430) and back side sheet 7 (440).

The resolved pages to be processed for sheet 6-7 are 81-112 in the case of a perfect bound imposition. The result of this calculation according to the described method will yield the following results:

from=81

to=112

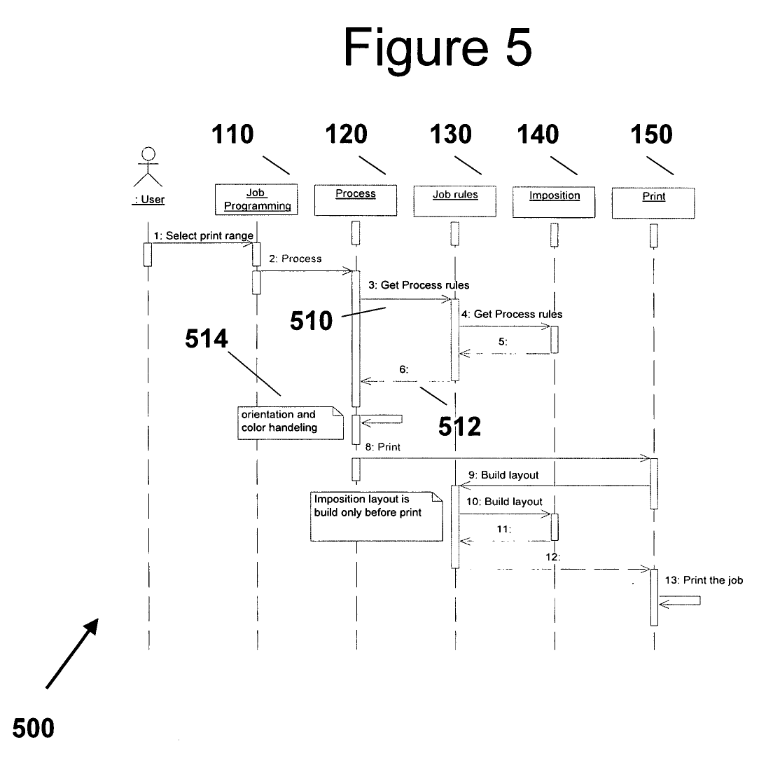

FIG. 5 describes a flowchart for page rules calculation 500. The rules which might represent a set of parameters which is required for processing of selected pages out of a print job. A list of such parameters may include, but not be limited to, the following list: page orientation, size, resolution, sheet side, destination profile, color space.

The disclosed method does not require execution of an imposition layout in order get the required parameters. Derived rules information might include information such as page orientation or color handling parameters required for pages in a job given the imposition scheme that will be used for the job.

The processing stage 120 needs to process a resolved page range calculated by the page resolve method described above. In order to process the requested page range page rules information should be calculated. The processing stage 120 initiate a request for page rules 510 information. Job rules stage 130 and the imposition stage 140 will return the pages rules parameters 512 to processing stage 120 in such as page orientation and color handling parameters 514.

The method for calculating process rules for resolved pages participating a given print job might differ as well between different imposition schemes. The examples below explain process rules calculation for resolved pages in the cases of saddle stitch, perfect bound and step, and continue imposition schemes.

Calculating process rules without calculation of imposition layout will yield the required individual page orientation degree (0/90/180/270). In the case where there is hardware assisted rotation supports 180 degrees rotation, processing stage 120 will rotate the pages by 0 or 90 degrees, which will be complemented by 180 degrees in hardware rotation to reach 180 and 270 degrees rotation when needed.

In the case where there is hardware assisted rotation supports rotation of 90 and 180 degrees processing stage 120 will not rotate the pages at all, all the rotation in this case will take place before the print stage 150. Rotation of small degree is used for tray alignment purposes. This type of rotation will be performed by processing stage 120 to compensate for tray requirements and according to where the page will be printed, in the front or back side of the sheet.

A method for process rules calculation for a resolved page range given a saddle stitch imposition is described hereunder in a Meta language form.

Process info for Saddle stitch

```
int pagesInSet //number of pages in a set, job round to full sheet
int pageNum//current calculated page
if pageNum <= (pagesInSet/2)
    int mod = pageNum % (uniquePagesInTemplate/2)
    Take template page with the same reminder -> take it's
    orientation and side
else
    sheet number = (int)Math.floor( (float) ((pagesInSet −
    pageNum) *2) / (float)uniquePagesInTemplate)
    int mod = pageNum − pagesInSet + ((uniquePagesInTemplate *
    (2+ sheet number)) / 2)
    Take template page with the same reminder -> take it's
    orientation and side
```

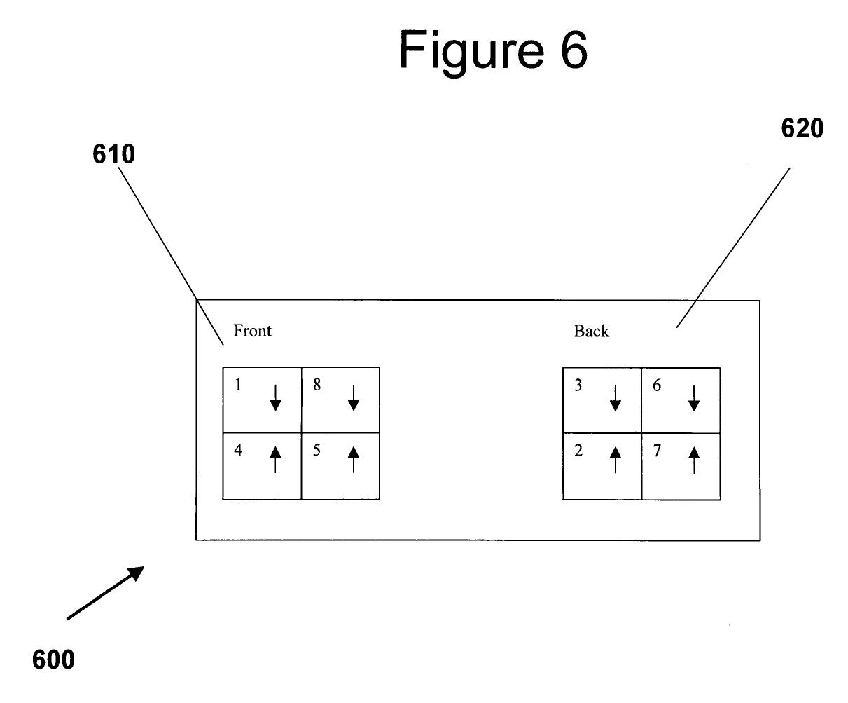

FIG. 6 describes a saddle stitch and perfect bound imposition template 600. Template 600 comprises a front side sheets template 610 and a back side sheets template 620. Template 600 is used for process rules calculation a given resolved pages for saddle stitch imposition.

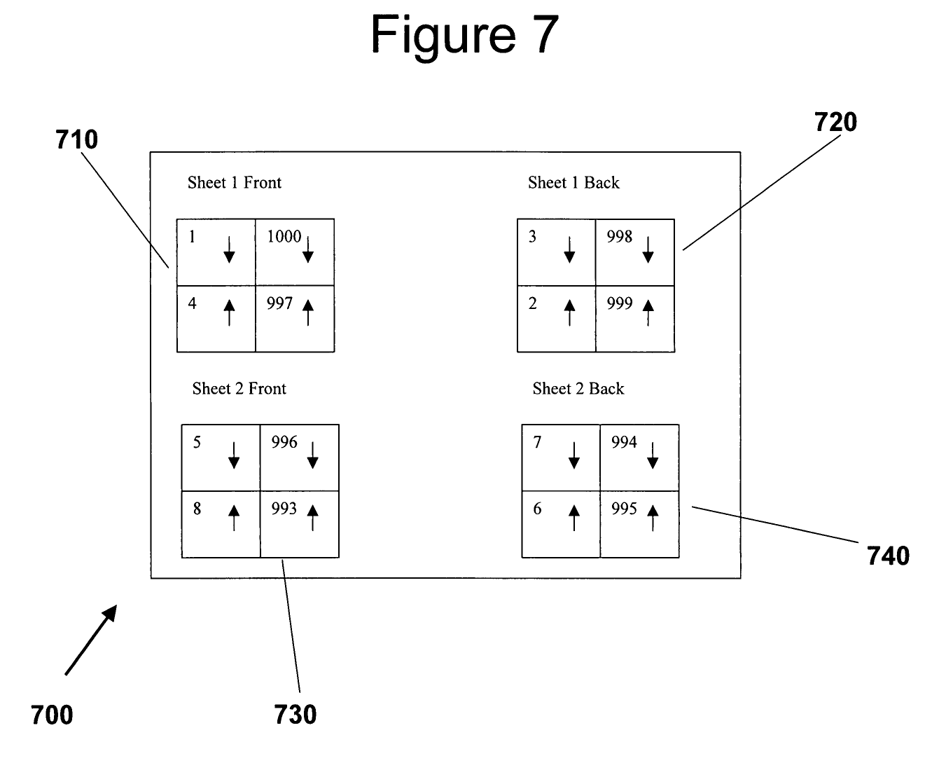

An example of a 1,000 page job is provided. FIG. 7 describes a saddle stitch imposition layout 700 of sheets 1-2 for the 1,000 page job. Layout 700 comprises the layouts of sheet 1 front 710, sheet 1 back 720, sheet 2 front 730 and sheet 2 back 740. The calculated results for the process rules according the described calculation method given a 1,000 page job, saddle stitch imposition for sheets 1-2 is as follows:

### Process Layout for Pages 1-8

Page 1 orientation 180 side Front Sheet number 1
Page 2 orientation 0 side Back Sheet number 1
Page 3 orientation 180 side Back Sheet number 1
Page 4 orientation 0 side Front Sheet number 1
Page 5 orientation 180 side Front Sheet number 2
Page 6 orientation 0 side Back Sheet number 2
Page 7 orientation 180 side Back Sheet number 2
Page 8 orientation 0 side Front Sheet number 2

### Process Layout for Pages 993-1000

Page 993 orientation 0 side Front Sheet number 2
Page 994 orientation 180 side Back Sheet number 2
Page 995 orientation 0 side Back Sheet number 2
Page 996 orientation 180 side Front Sheet number 2
Page 997 orientation 0 side Front Sheet number 1
Page 998 orientation 180 side Back Sheet number 1
Page 999 orientation 0 side Back Sheet number 1
Page 1000 orientation 180 side Front Sheet number 1

A method for process rules calculation for a resolved page range given a perfect bound is described hereunder in a Meta language form.

Process info for Perfect bound

int uniquePagesInTemplate // unique pages in template
int mod = pageNum % uniquePagesInTemplate;
Take template page with the same reminder -> take it's orientation
and side
To calculate sheet number, we calculate the flat number (side)
// templatePageNo - the number of matched reminder template number
// uniquePagesInFlat - unique pages in one flat
int flatNum = (pageNum − templatePageNo) / uniquePagesInFlat

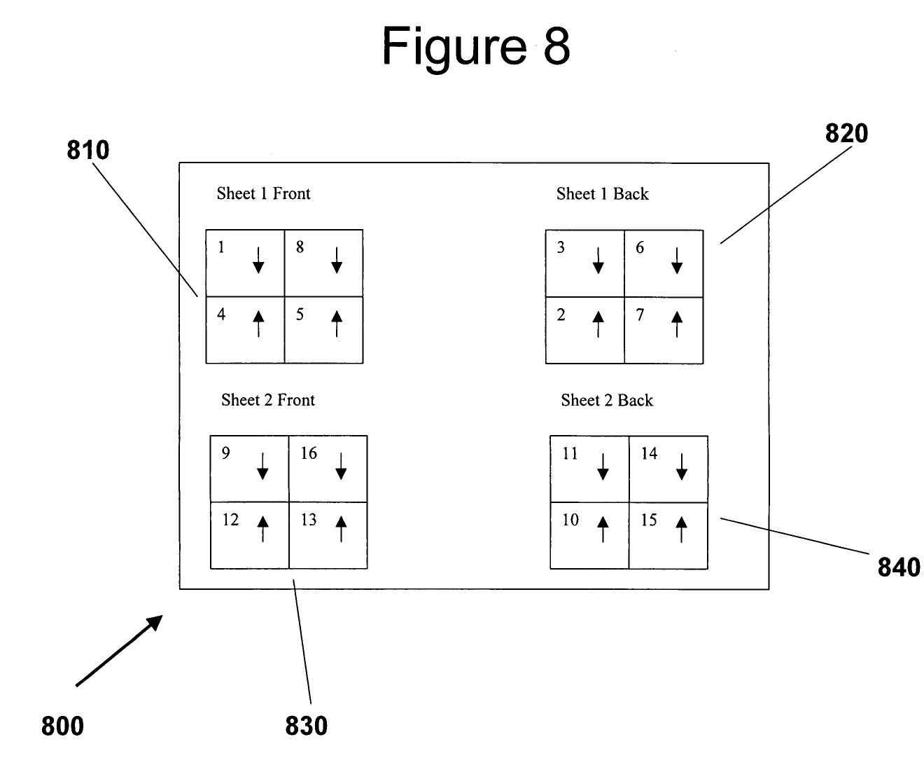

An example of a 350 page job is provided. FIG. 8 describes a perfect bound imposition layout 800 of sheets 1-2 for the 350 page job. Layout 800 comprises the layouts of sheet 1 front 810, sheet 1 back 820, sheet 2 front 830 and sheet 2 back 840.

The calculated results for the process rules according the described calculation method given a 350 page job, perfect bound imposition for sheets 1-2 is as follows:

### Process Layout for Pages 1-16

Page 1 orientation 180 side Front Sheet number 1
Page 2 orientation 0 side Back Sheet number 1
Page 3 orientation 180 side Back Sheet number 1
Page 4 orientation 0 side Front Sheet number 1
Page 5 orientation 0 side Front Sheet number 1
Page 6 orientation 180 side Back Sheet number 1
Page 7 orientation 0 side Back Sheet number 1
Page 8 orientation 180 side Front Sheet number 1
Page 9 orientation 180 side Front Sheet number 2
Page 10 orientation 0 side Back Sheet number 2
Page 11 orientation 180 side Back Sheet number 2
Page 12 orientation 0 side Front Sheet number 2
Page 13 orientation 0 side Front Sheet number 2
Page 14 orientation 180 side Back Sheet number 2
Page 15 orientation 0 side Back Sheet number 2
Page 16 orientation 180 side Front Sheet number 2

The invention has been described in detail with particular reference to certain preferred embodiments thereof, but it will be understood that variations and modifications can be effected within the scope of the invention.

### PARTS LIST

100 flowchart for calculation of pages required for page processing
110 job programming stage
112 sheet print range
120 processing stage
130 job rules stage
132 start resolving page range
134 list of resolved pages
136 process resolved pages
140 imposition stage
142 build imposition layout
150 print stage
152 start print
154 print the job
200 saddle stitch and perfect bound imposition template (4×2)
210 front side sheets template 200
220 back side sheets template 200
300 example of a layout sheet (4-5)
310 front side sheet 4
320 back side sheet 4
330 front side sheet 5
340 back side sheet 5
400 example of a layout sheet (6-7)
410 front side sheet 6
420 back side sheet 6
430 front side sheet 7
440 back side sheet 7
500 flowchart for calculation of pages rules required for page processing
510 start getting page rules
512 gets pages rules
514 page orientation and color handling parameters
600 saddle stitch and perfect bound imposition template (2×2)
610 front side sheets template 600
620 back side sheets template 600
700 an example of saddle stitch imposition for 1000 pages layout sheet (1-2)
710 front side sheet 1 (imposition 700)
720 back side sheet 1
730 front side sheet 2
740 back side sheet 2
800 an example of perfect bound imposition for 350 pages layout sheet (1-2)
810 front side sheet 1 (imposition 800)
820 back side sheet 1
830 front side sheet 2
840 back side sheet 2

1. A method for calculating properties of printing elements wherein said printing elements are part of a print job comprising the steps of:
a) providing a range of sheets for printing;
b) providing desired imposition schemes for said print job; and
c) calculating a set of printing elements required for said range of sheets for printing according to said desired imposition schemes.

2. A method as in claim 1 further comprising:
d) splitting said set of printing elements into a plurality of printing element subsets wherein each of said subsets contains less printing elements than said set of printing elements;
e) calculating processing parameters for each of said printing element subsets wherein said processing parameters are required for processing of said printing elements; and
f) wherein said calculation of said printing elements and said processing parameters is performed without calculation of an imposition layout of said sheets.

3. A method according to claim 1 wherein each sheet comprises a plurality of printing elements.

4. A method according to claim 1 wherein each printing element is a digital page.

5. A method according to claim 1 wherein each printing element is part of a digital page.

6. A method according to claim 1 wherein each sheet comprises a front side and a back side.

7. A method according to claim 1 wherein said imposition schemes comprise at least one of a group comprising saddle stitch, perfect bound, cut and stack, step and repeat, step and continue imposition schemes or a combination thereof.

8. A method according to claim 2 wherein said processing parameters comprise at least one of a group comprising orientation, size, resolution, sheet side, destination profile, color space, or a combination thereof.
